(19) United States
(12) Patent Application Publication
(10) Pub. No.: US 2006/0196606 A1
(43) Pub. Date: Sep. 7, 2006

(54) MANUFACTURING METHOD OF LAMINATED CARD, LAMINATING APPARATUS AND CARD PRINTING APPARATUS THEREOF

(75) Inventors: Tomonori Sumida, Yamato-shi, (JP); Toshinori Takahashi, Nakahara-ku, Kawasaki-shi (JP)

Correspondence Address: CONNOLLY BOVE LODGE & HUTZ LLP, SUITE 800, 1990 M STREET NW, WASHINGTON, DC, 20036-3425, US

(73) Assignee: VICTOR COMPANY OF JAPAN, LIMITED, Kanagawa-ku (JP)

(21) Appl. No.: 11/306,836

(22) Filed: Jan. 12, 2006

(30) Foreign Application Priority Data
Feb. 18, 2005 (JP) 2005-04188

(51) Int. Cl. B32B 37/00; B65C 9/46

(52) U.S. Cl. 156/350; 156/362; 156/387

(57) ABSTRACT

A laminating apparatus 100 is composed of a laminating section LR for thermally compression bonding a laminate film 2 having a material for forming a protective film 2a on at least one surface 1a of a card 1 recorded with information and for bonding the protective film 2a on the one surface 1a of the card 1 while the card 1 is carried through the laminating section LR, a supplying section 101 for supplying the card 1 to the laminating section LR, carrying means R1 and R2 for carrying the card 1 supplied from the supplying section 101 so as to pass through the laminating section LR at a prescribed passing through speed, and a controlling section 304 for controlling the passing through speed in the laminating section LR, wherein the controlling section 304 controls the passing through speed such that a finishing moment speed V2f when the card 1 finishes to pass through the laminating section LR is slower than a starting moment speed V2s when the card 1 starts to pass through the laminating section LR, and wherein the controlling section 304 controls the passing through speed so as not to be increased within a range from the starting moment speed V2s to the finishing moment speed V2f.

### BACKGROUND OF THE INVENTION

1. Field of the Invention

The present invention relates to a manufacturing method of a laminated card of which surface is laminated with a protective film, a laminating apparatus for laminating a protective film on a surface of a card and a card printing apparatus, which prints information on a surface of a card and then conducts a laminating process thereon.

2. Description of the Related Art

As a full-blown card era has come, various kinds of cards have normally been used in daily life. Such a card is, for example, a card of which surface is printed with specific information, a magnetic card such as a telephone card, and an IC card in which an IC memory chip is installed as represented by a credit card. In case of applications for identifying a person, an image such as a facial portrait of the person is printed on a surface of a card.

It is often the case that those various kinds of cards are laminated with a protective film on their surfaces so as to protect their surfaces from scratching or stain, or so as to prevent information printed thereon from being altered.

More specifically, by thermally compression bonding a transparent film in ribbon shape having a thickness of approximately 10 μm to 30 μm on a surface of a card, which was previously printed with information, the transparent film is bonded on the surface of the card and results in a protective film.

A laminating apparatus for conducting the laminating process is disclosed in the Japanese publication of unexamined patent applications No. 2004-1236.

The laminating apparatus disclosed in the Japanese publication of unexamined patent applications No. 2004-1236 laminates a protective body (laminate film), which is formed with a resin layer to be a protective layer on a substrate such as PET (polyethylene terephthalate), on a surface of a recording medium such as a card, which is made from plastic or woodfree paper through a thermo compression bonding process by means of a heat roller, and resulting in laminating the resin layer on the surface of the card.

In the manufacturing process of such a laminated card mentioned above, there existed a possible problem such that the laminated card is easily warped by heat applied to the card and the laminate film during the laminating process.

In this connection, less expensive PVC (polyvinyl chloride) is used for a card as a material, in general, and PET is preferably used for a laminate film.

However, these materials are different from each other in thermal expansion coefficient, and further PVC is low in glass transition point. Consequently, in case a card is made from PVC and a laminate film is made from PET, a laminated card is easily warped when the laminate film and the card are heated in higher temperature during the laminating process.

In case a laminated card is deformed by such warpage, the laminated card is deteriorated in grade of appearance.

Further, in case the card is a magnetic card or printed with a bar code, the warped card results in problems such as defective in reading out magnetic data from or recording magnetic data in such a warped magnetic card and defective in reading out bar code data from such a warped card printed with a bar code.

In order to solve such warpage of a card, the Japanese publication of unexamined patent applications No. 2004-1236 proposed the laminating apparatus provided with the corrective device in the downstream side of the thermo compression bonding device for conducting the laminating process. The corrective device acts on warpage of both side edges of the card to correct independently, wherein a side edge is an edge along the card in the direction of carrying the card.

By the way, a card to be carried is thermally compressed by a heat roller during the laminating process. According to an analysis of laminated cards performed by the inventors of the present invention, it became clear that adhesive strength of a protective film, which is laminated on a card, relative to the card was weaker in the back end side of the card in comparison with that of the front end side of the card with respect to the card carrying direction.

More specifically, the adhesive strength of the protective film is strongest at the front end portion of the card and gradually decreases toward the back end portion of the card. Consequently, the adhesive strength is weakest at the back end portion of the card.

This is surmised such that a front end portion of a card laminated with a laminate film is compressed and sufficiently heated by a heat roller of which temperature is raised as high as a prescribed temperature when the laminated card is heated by the heat roller. In other words, the front end portion of the laminated card is sufficiently heated by the heat roller, and results in strongest in adhesive strength. However, temperature of the card and the laminate film is lower than that of the heat roller, so that heat accumulated in the heat roller is transferred from the heat roller to the card and the laminate film. Consequently, temperature of the heat roller gradually decreases in accordance with the card being carried by degrees.

A laminated card of which adhesive strength of a laminate film is partially degraded due to uneven adhesive strength of the laminate film creates a problem such that the laminate film possibly peels off according to storage surroundings or change with time.

In order to cope with the problem, it has been studied that a heat roller was set to higher temperature so as to be able to obtain enough adhesive strength even at the rear end portion of a card at where the adhesive strength was deteriorated maximally.

In this case, however, the card was excessively heated in accordance with a direction toward the front end portion of the card, and resulting in creating another problem such that the card was distinctly deformed.

Further, such a distinctly deformed card is hardly corrected even by the conventional correction method conducted by the corrective device that is disclosed in the Japanese publication of unexamined patent applications No. 2004-1236.

On the other hand, in case of a card printing apparatus equipped with a laminating function, such a card printing apparatus is constituted by furnishing a printing mechanism and a laminating mechanism corresponding to a laminating device, which are directly connected therein, wherein a laminating process is conducted immediately after printing.

In the process of printing information on a surface of a card, a printing method such as the thermal transfer printing method has been well known as the printing method, which requires heating to be applied to the card.

In case of the thermal transfer printing method, for example, a card itself is heated by a heat transfer roller, and temperature of the card is raised up to high temperature of 40° C. to 50° C. much higher than the normal temperature.

Whereby, in case the laminating process is conducted to a card immediately after the printing process, the card of which temperature is not yet cooled down as low as the normal temperature is supplied to the laminating device and further the card is added with extra heat for laminating therein.

Accordingly, the card mentioned above is conducted through the laminating process with having higher temperature much higher than the normal temperature, and the card is excessively heated in a wide area of the card not only the front end portion in the card carrying direction but also an area extending toward the rear end portion, and resulting in arising a problem such that the card is extremely deformed.

Further, in case a heating element such as a power source and a heater is provided nearby a card stocking section or a card carrying route inside a printing device although the printing device does not heat a card when printing, card temperature is raised higher by heat generated by the heating element, and possibly resulting in arising a similar problem as mentioned above.

In order to solve such a problem, it has been eagerly desired to realize a manufacturing method of a laminated card, a laminating apparatus and a card printing apparatus for producing a laminated card, which ensure a laminated card that is free from distinctive deformation and high in reliability and quality.

Further, such a manufacturing method, a laminating apparatus or a card printing apparatus has been expected to ensure a laminated card in which adhesive strength of a protective film is not uneven but sufficient.

### SUMMARY OF THE INVENTION

Accordingly, in consideration of the above-mentioned problems of the prior art, an object of the present invention is to provide a manufacturing method of a laminated card, a laminating apparatus and a card printing apparatus that enable to manufacture a laminated card, which ensure a laminated card that is free from deformation and high in reliability and quality, wherein a protective film laminated on a surface of a card is sufficiently high in adhesive strength relative to the card, and further the adhesive strength is uniform in a whole area of the card.

According to an aspect of the present invention, there provided a manufacturing method of a laminated card formed with a protective film on a surface of a card, comprising the step of thermo compression bonding for thermally compression bonding a laminate film having a material for forming a protective film on at least one surface of a card while the card is carried through a thermo compression bonding section at a prescribed passing through speed, wherein the passing through speed is designated such that a finishing moment speed when the card finishes to pass through the thermo compression bonding section is slower than a starting moment speed when the card starts to pass through the thermo compression bonding section, and wherein the card is carried without increasing the passing through speed within a range from the starting moment speed to the finishing moment speed.

According to another aspect of the present invention, there provided a laminating apparatus for manufacturing a laminated card comprising: a laminating section for thermally compression bonding a laminate film having a material for forming a protective film on at least one surface of a card recorded with information and for bonding the protective film on the one surface of the card while the card is carried through the laminating section; a supplying section for supplying the card to the laminating section; carrying means for carrying the card supplied from the supplying section so as to pass through the laminating section at a prescribed passing through speed; and a controlling section for controlling the passing through speed in the laminating section, wherein the controlling section controls the passing through speed such that a finishing moment speed when the card finishes to pass through the laminating section is slower than a starting moment speed when the card starts to pass through the laminating section, and wherein the controlling section controls the passing through speed so as not to be increased within a range from the starting moment speed to the finishing moment speed.

According to a further aspect of the present invention, there provided a card printing apparatus for manufacturing a laminated card comprising: a printing section for printing information on at least one surface of a card; and a laminating section for thermally compression bonding a laminate film having a material for forming a protective film on the one surface of the card printed with the information in the printing section and for bonding the protective film on the one surface of the card while the card is carried through the laminating section, the card printing apparatus further comprising: carrying means for supplying the card printed in the printing section to the laminating section and for carrying the card so as to pass through the laminating section at a prescribed passing through speed; and a controlling section for controlling the passing through speed in the laminating section, wherein the controlling section controls the passing through speed such that a finishing moment speed when the card finishes to pass through the laminating section is slower than a starting moment speed when the card starts to pass through the laminating section, and wherein the controlling section controls the passing through speed so as not to be increased within a range from the starting moment speed to the finishing moment speed.

Other object and further features of the present invention will be apparent from the following detailed description when read in conjunction with the accompanying drawings.

### BRIEF DESCRIPTION OF THE DRAWINGS

FIG. 1 is a plan view of a laminating apparatus according to a first embodiment of the present invention showing an internal constitution.

FIG. 2 is a plan view of a driving mechanism adopted in the laminating apparatus shown in FIG. 1 and a laminating section according to a second embodiment of the present invention.

FIG. 3 is an electrical block diagram of the laminating apparatus and the laminating section according to each embodiment of the present invention.

FIG. 4 is a timing chart of the laminating apparatus shown in FIG. 1 according to the first embodiment of the present invention.

FIG. 5(a) is a plan view showing a frame format of a major part of the laminating apparatus shown in FIG. 1 according to the first embodiment of the present invention.

FIG. 5(b) is a plan view of a laminate film viewed from an arrow “A” direction in FIG. 5(a).

FIG. 6 is a plan view of a card carrying-out section of the laminating apparatus and the laminating section according to each embodiment of the present invention.

FIG. 7 is a plan view showing a frame format of a card printing apparatus according to a second embodiment of the present invention.

FIG. 8(a) is a graph exhibiting a control pattern of a laminating speed in a linear mode that is conducted in the laminating apparatus according to the first embodiment of the present invention.

FIG. 8(b) is a graph exhibiting a control pattern of a laminating speed in a multistep mode that is conducted in the laminating apparatus according to the first embodiment of the present invention.

FIG. 8(c) is a graph exhibiting a control pattern of a laminating speed in a single step mode that is conducted in the laminating apparatus according to the first embodiment of the present invention.

### DETAILED DESCRIPTION OF THE PREFERRED EMBODIMENTS

Prior to describing each embodiment in detail, some definitions common to each embodiment shall be described as a matter of first priority.

With respect to a direction of a card to be carried, a direction toward a card carrying-out slot and another direction toward a card intake slot are defined as a forward direction and a backward direction respectively. It is understood that the backward direction is an opposite direction to the forward direction.

### First Embodiment

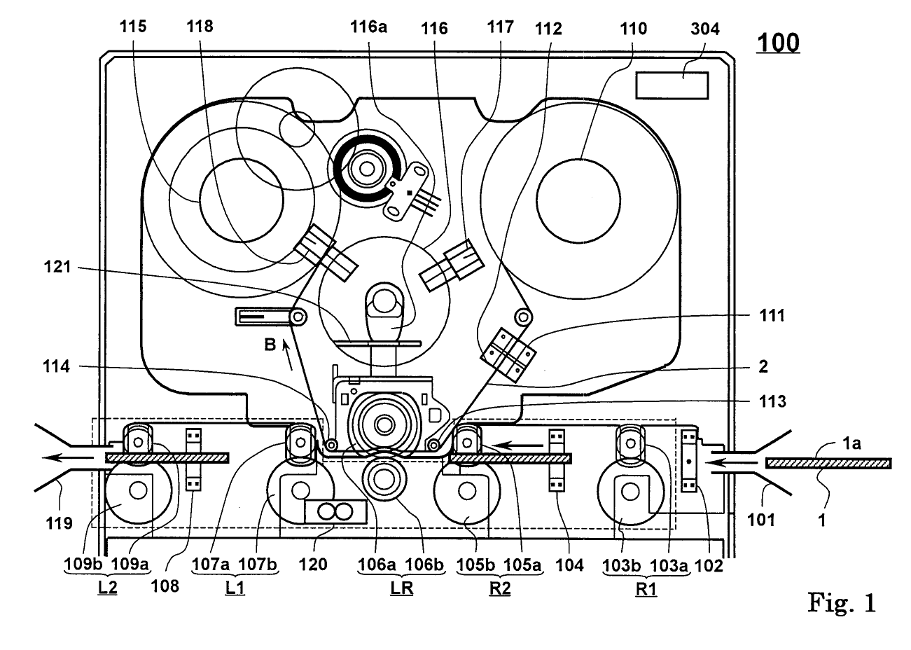

FIG. 1 is a plan view of a laminating apparatus according to a first embodiment of the present invention showing an internal constitution.

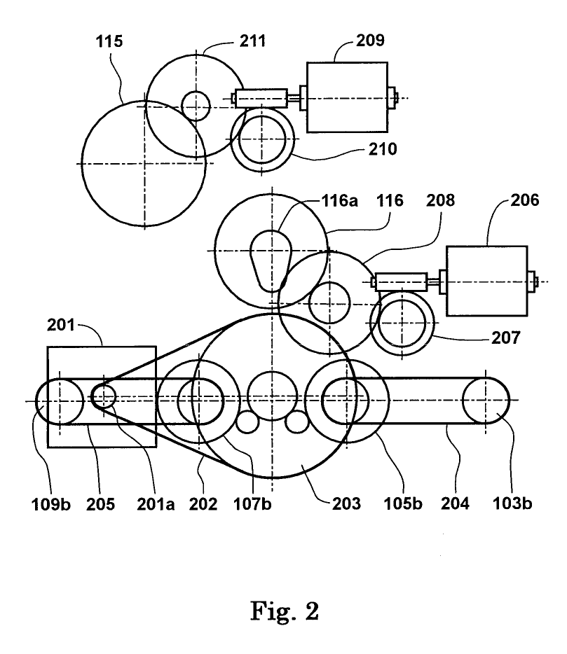

FIG. 2 is a plan view of a driving mechanism adopted in the laminating apparatus shown in FIG. 1.

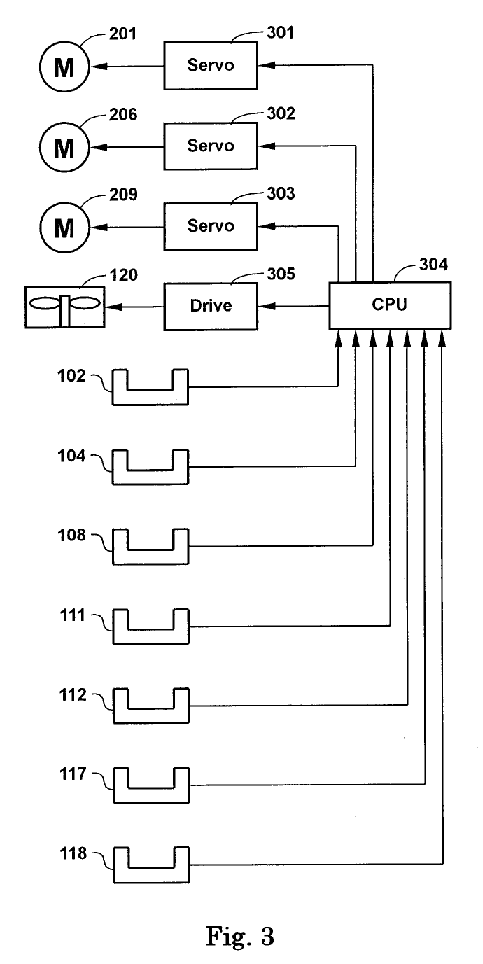

FIG. 3 is an electrical block diagram of the laminating apparatus shown in FIG. 1.

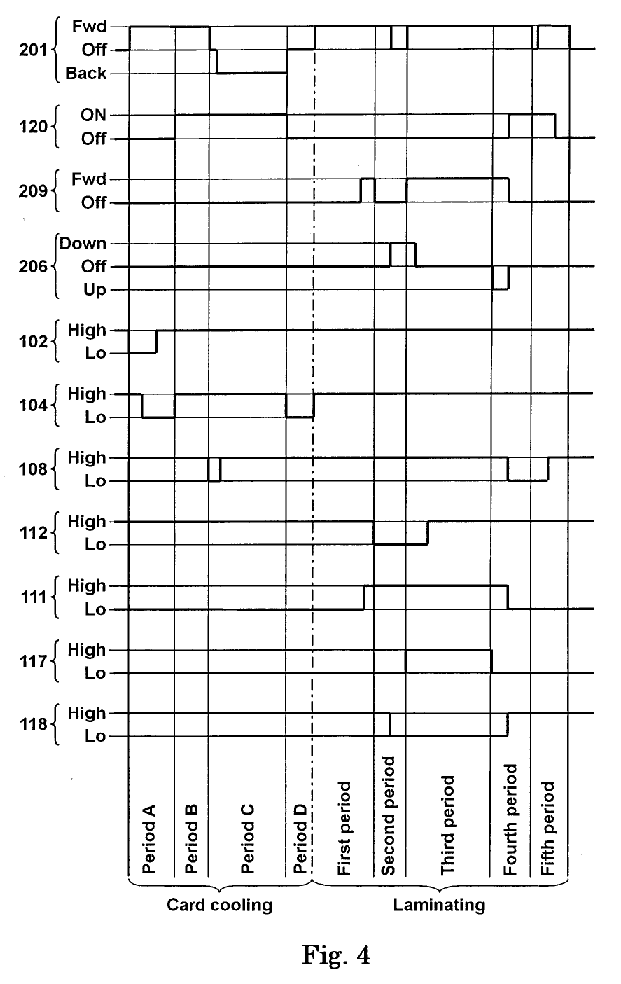

FIG. 4 is a timing chart of the laminating apparatus shown in FIG. 1 according to the first embodiment of the present invention.

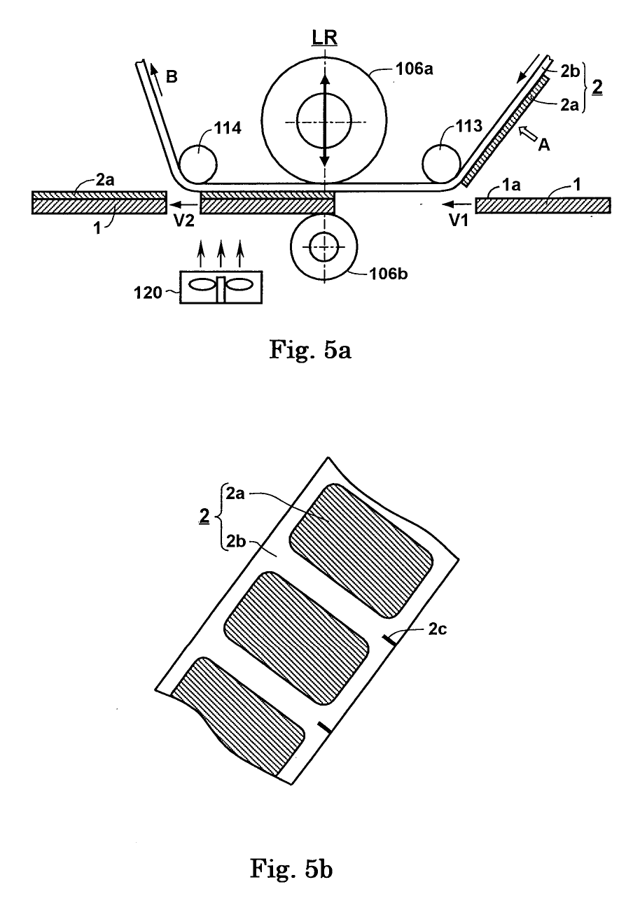

FIG. 5(a) is a plan view showing a frame format of a major part of the laminating apparatus shown in FIG. 1 according to the first embodiment of the present invention.

FIG. 5(b) is a plan view of a laminate film viewed from an arrow “A” direction in FIG. 5(a).

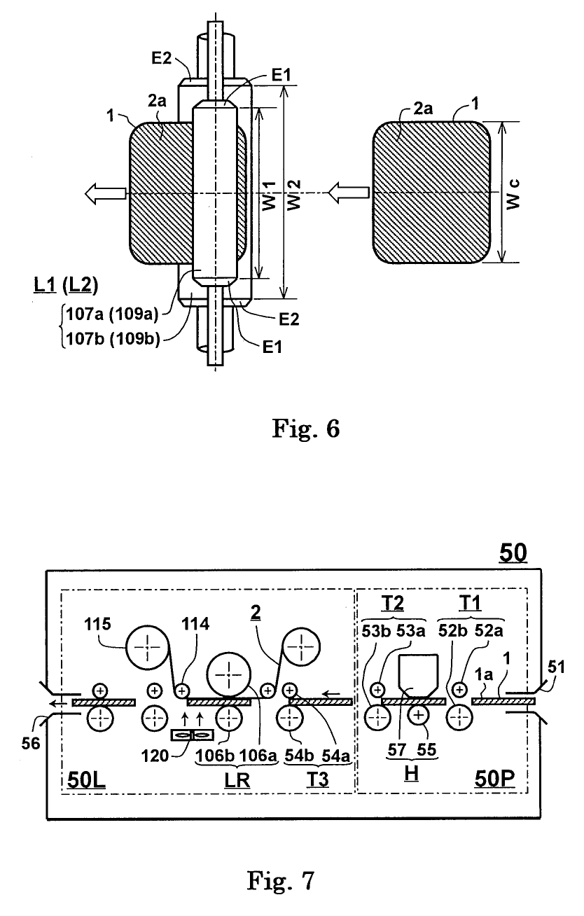

FIG. 6 is a plan view of a card carrying-out section of the laminating apparatus shown in FIG. 1 according to the first embodiment of the present invention.

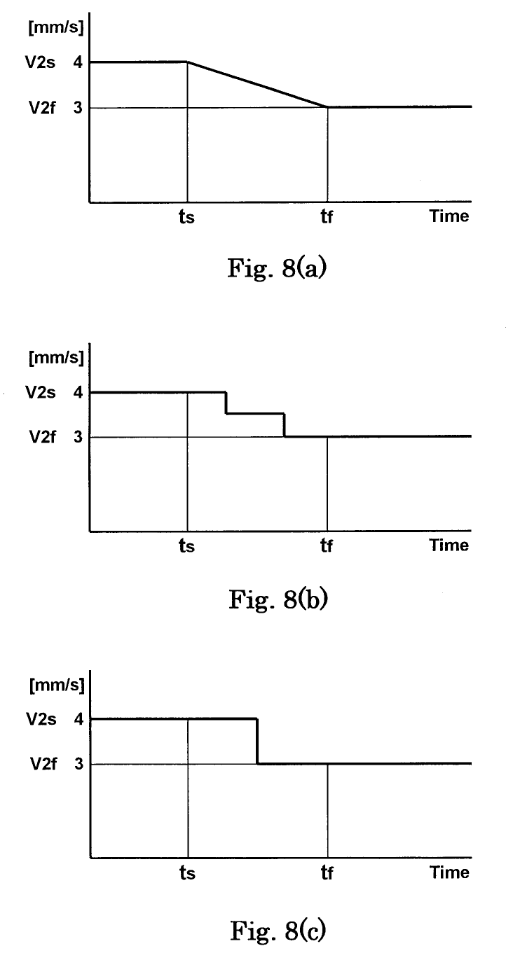

FIGS. 8(a) to 8(c) are graphs exhibiting control patterns of a laminating speed in a linear mode, a multistep mode and a single step mode respectively, wherein the control patterns are conducted in the laminating apparatus according to the first embodiment of the present invention.

With referring to FIG. 1, a laminating apparatus according to a first embodiment of the present invention is depicted in detail.

In FIG. 1, a laminating apparatus 100 is an apparatus for laminating a protective film on a surface 1a of a card 1, which is previously recorded or printed with information.

More specifically, the laminating apparatus 100 conducts a laminating process on the surface 1a of the card 1. Firstly, the card 1 is inserted into a card intake slot 101. Secondly, the card 1 is conducted through a laminating process, and finally the card 1 that is laminated with the protective film is carried out from a card carrying-out slot 119.

Further, the card 1 exemplified in the first embodiment is made from PVC (polyvinyl chloride), for example. However, it shall be understood that a material of the card 1 is not limited to PVC and any other materials such as thermo plastics and paper are applicable for the card 1.

The laminating apparatus 100 is specifically described in detail next along a carrying route of the card 1 from the card intake slot 101 to the card carrying-out slot 119.

As shown in FIG. 1, the laminating apparatus 100 is composed of the card intake slot 101, a card detecting sensor 102, a first card carrying-in roller section R1 that is constituted by a pair of a press shaft 103a and a card carrying roller 103b, a laminating position sensor 104, a second card carrying-in roller section R2 that is constituted by a pair of a press shaft 105a and a card carrying roller 105b, a laminating section (hereinafter referred to as laminating roller section) LR for thermo compression bonding that is constituted by a pair of heat roller 106a and a heat press shaft 106b, a first card carrying-out roller section L1 that is constituted by a pair of a press shaft 107a and a card carrying roller 107b, a card carrying-out sensor 108, a second card carrying-out roller section L2 that is constituted by a pair of a press shaft 109a and a card carrying roller 109b, the card carrying-out slot 19, and a cooling fan 120. The cooling fan 120 is allocated in a downstream side of the laminating roller section LR nearby the carrying route of the card 1.

Hereupon, the card intake slot 101, the first card carrying-in roller section R1 and the second card carrying-in roller section R2 constitute a card carrying-in route.

Further, the first card carrying-out roller section L1, the second card carrying-out roller section L2 and the card carrying-out slot 119 constitute a card carrying-out route.

Furthermore, the card carrying-in route and the card carrying-out route are generically referred to as a carrying route of the card 1.

In the carrying route of the card 1, the laminating roller section LR conducts a thermo compression bonding process (hereinafter generically referred to as laminating process).

In addition thereto, the laminating apparatus 100 is further composed of a laminate film feeding section (to be detailed later) and a controlling section 304 for controlling the laminating apparatus 100 totally, wherein the controlling section 304 is hereinafter referred to as CPU (Central Processing Unit) 304.

With referring to FIG. 6, functions and operations of the press shafts 107a and 109a and the card carrying rollers 107b and 109b, which constitute the first and second card carrying-out roller sections L1 and L2 respectively, are described next.

FIG. 6 is a plan view of the first and second card carrying-out roller sections L1 and L2 viewed from above a protective film 2a side of the card 1, that is, viewed from the press shaft 107a or 109a side in FIG. 1. A configuration of the second card carrying-out roller section L2 is similar to that of the first card carrying-out roller sections L1, so that description is given to the first card carrying-out roller sections L1 as a representative of the first and second card carrying-out roller sections L1 and L2.

A width W1 of a section of the press shaft 107a having a maximal outer diameter and a width W2 of a section of the card carrying roller 107b having a maximal outer diameter are designated to be approximately equal to or larger than a width Wc of the card 1 respectively.

In this connection, since an end portion El of the press shaft 107a and an end portion E2 of the card carrying roller 107b never contact with the card 1, which is carried in an arrow direction in FIG. 6, respectively, a whole surface area of the card 1 that is laminated with a protective film 2a is pressed evenly by the press shaft 107a and the card carrying roller 107b, and resulting in eliminating deviation of internal stress remaining in the card 1. In other words, the card 1 is uniformized in lower stress after the laminating process.

Consequently, the surface of the laminated card 1, that is, a surface of the protective film 2a, which is laminated on the surface 1a of the card 1 by the laminating roller section LR, is hardly scratched by the first and second card carrying-out roller sections L1 and L2, and further the protective film 2a is prevented from wrinkling although the protective film 2a is still in higher temperature and soft.

Furthermore, evenly pressing the protective film 2a eliminates unevenness of bonding the protective film 2a to the card 1, and the protective film 2a results in hardly peeling off by itself with time.

Referring back to FIG. 1, the laminate film feeding section is described in detail next. The laminate film feeding section is composed of the laminate film 2, a supply reel 110, an end mark sensor 111 for detecting a mark (to be detailed later) on the laminate film 2, a film mark sensor 112, a first guide shaft 113, a second guide shaft 114, a take-up roller 115, a heat cam 116, a heat cam pressure position sensor 117, a heat cam stand-by position sensor 118, and a lever 121. The heat cam 116 is provided with a cam section 116a in prescribed shape. Hereupon, the heat cam 116, the heat cam pressure position sensor 117 and the heat cam stand-by position sensor 118 will be detailed later.

The laminate film 2 to be supplied for laminating is extended from the supply reel 110 to the take-up reel 115 through the laminating roller section LR between the heat roller 106a and the heat press shaft 106b.

Further, as shown in FIG. 1, the end mark sensor 111, the film mark sensor 112, and the first and second guide shafts 113 and 114 are allocated on an extending route of the laminate film 2 respectively.

With referring to FIGS. 1 and 5(a), the laminating process is briefly described next.

FIG. 5(a) is a plan view showing a frame format of the laminating roller section LR and its neighboring area for exhibiting the laminating process conducted by the laminating roller section LR. In FIG. 5(a), the laminate film 2 is extended along the first and second guide shafts 113 and 114 through the laminating roller section LR between the heat roller 106a and the heat press shaft 106b while the laminate film 2 is carried in an arrow “B” direction. The card 1 is carried in from the card intake slot 101 at a card carrying speed V1. Then, the card 1 is carried in the laminating roller section LR, wherein a protective film 2a provided on a substrate 2b of the laminate film 2 is thermally compression bonded on the surface 1a of the card 1 by the heat roller 106a that presses the card 1 and the laminate film 2 against the heat press shaft 106b while the card 1 is carried at a prescribed passing through speed (hereinafter referred to as laminating speed) V2.

Accordingly, the protective film 2a is laminated on the surface 1a of the card 1.

With referring to FIGS. 1 and 2, a driving system of the laminating apparatus 100 is described in detail next.

Allocation of each component shown in FIG. 2 corresponds to that shown in FIG. 1. In FIG. 2, the components such as the card carrying rollers 103b, 105b, 107b and 109b and the heat cam 116 and the take-up reel 115 are common to those shown in FIG. 1.

The laminating apparatus 100 is provided with a card carrying motor 201, a heat cam motor 206 and a film take-up motor 209 as a driving source.

Motive power of the card carrying motor 201 is transmitted through first to third power transmission routes.

More specifically, with respect to a first power transmission route, the motive power of the card carrying motor 201 is transmitted to an idle gear 203 by way of a motor pulley 201a and a first belt 202, and further transmitted to the card carrying roller 105b of the second card carrying-in roller section R2, which engages with the idle gear 203.

With respect to a second power transmission route, the motive power is also transmitted to the card carrying roller 103b of the first card carrying-in roller section R1 by way of a second belt 204, which is wound around the card carrying roller 105b.

With respect to a third power transmission route, the motive power is transmitted to the card carrying roller 107b of the first card carrying-out roller section L1, which engages with the idle gear 203 through another idle gear, and further transmitted to the card carrying roller 109b of the second card carrying-out roller section L2 by way of a third belt 205.

On the other hand, motive power of the heat cam motor 206 is transmitted to the heat cam 116 by way of a worm wheel 207 and an idle gear 208, which engages with the worm wheel 207.

As shown in FIGS. 1 and 2, the heat cam 116 is provided with the cam section 116a in prescribed shape.

The lever 121 shown in FIG. 1 contacts with the cam section 116a while the lever 121 pushes the cam section 116a upward, and reciprocally moves in the vertical direction with sliding along the outer circumferential surface of the cam section 116a when the heat cam 116 rotates. The lever 121 is linked to the heat roller 106a, so that the heat roller 106a moves vertically in accordance with rotation of the heat cam 116 as a result.

Further, a rotational position of the heat cam 116 is detected by the heat cam pressure position sensor 117 and the heat cam stand-by position sensor 118.

More specifically, the heat cam 116 rotates clockwise in FIG. 1 and moves the heat roller 106a downward toward the heat press shaft 106b, and then the heat cam pressure position sensor 117 detects a moment when the heat roller 106a begins to be pressed against the heat press shaft 106b.

On the contrary, the heat cam stand-by position sensor 118 detects a moment when the heat roller 106a begins to be apart from the heat press shaft 106b.

On the other hand, motive power of the film take-up motor 209 is transmitted to the take-up reel 115 by way of a worm wheel 210 and an idle gear 211, which engages with the worm wheel 210.

With referring to FIG. 3, an electrical configuration of the laminating apparatus 100 is described next. The laminating apparatus 100 is provided with the CPU 304 as a controlling device. As shown in FIG. 3, sensor output information from the card detecting sensor 102, the laminating position sensor 104, the card carrying-out sensor 108, the end mark sensor 111, the film mark sensor 112, the heat cam pressure position sensor 117 and the heat cam stand-by position sensor 118 are inputted into the CPU 304.

Further, the CPU 304 is connected to servo circuits 301, 302 and 303, which are hooked up to the card carrying motor 201, the heat cam motor 206 and the film take-up motor 209 respectively.

Furthermore, the CPU 304 is connected to a drive amplifier 305, which is hooked up to the cooling fan 120.

By this electrical configuration, the CPU 304 enables to control the cooling fan 120 through the drive amplifier 305 as well as controlling each of the motors 201, 205 and 209 through each of the servo circuits 301, 302 and 303 respectively in response to each sensor output information to be inputted into the CPU 304.

With referring to FIGS. 1 to 5(b), the laminating operation in the laminating apparatus 100 according to the first embodiment of the present invention is described in detail next.

The laminating operation of the laminating apparatus 100 is divided broadly into two phases. The one is a laminating operation phase for conducting a laminating process to a card 1, and the other is a card cooling operation phase that is a preceding phase prior to the laminating operation phase.

The laminating operation phase is further divided into five periods from a first period to a fifth period, and the card cooling operation phase is further divided into four periods from a period “A” to a period “D”.

In the laminating apparatus 100, when laminating a protective film 2a on a card 1, the CPU 304 controls the laminating speed V2 shown in FIG. 5(a) with respect to the card 1 and the laminate film 2 in multiple stage of speed so as to optimize lamination quality in accordance with variations of the card 1 or the laminate film 2 in material and thickness.

More specifically, in the laminating apparatus 100, the laminating speed V2 enables to be adjusted within a range from 4.0 mm/s to 9.0 mm/s by an interval of 0.5 mm/s.

Further, as it will be detailed, the setting of the laminating speed V2 enables to be controlled so as to be changed in response to a location of the card 1 during the laminating operation other than controlling the laminating speed V2 in a constant speed.

Hereupon, the laminate film 2 is described briefly. There are two types of films. The one is a so-called “patch film” that is constituted by a piece of laminate film or protective film 2a having a size almost equivalent to that of the card 1, which is successively bonded on a base film or substrate 2b as shown in FIG. 5(b). The other is a so-called an “overlay film” that is constituted by a thermo adhesive resin, which enables to be thermally bonded on a surface of the card 1 and is coated on a base tape or substrate in ribbon shape.

In the following descriptions of the laminating operation, it is described by using a patch film type laminate film.

With referring to FIG. 4, a description is given to the card cooling operation phase first.

In FIG. 4, three digit numbers exhibited at the far left of the chart such as 201, 120, 209, 206, 102, 104, 108, 112, 111, 117 and 118 denote the card carrying motor 201, the cooling fan 120, the film take-up motor 209, the heat cam motor 206, the card detecting sensor 102, the laminate position sensor 104, the card carrying-out sensor 108, the film mark sensor 112, the end mark sensor 111, the heat cam pressure position sensor 117 and the heat cam stand-by position sensor 118 respectively.

Further, in FIG. 4, terms “Fwd”, “Back” and “Lo” denote “forward”, “backward” and “low” respectively. In case of the card carrying motor 201, for example, the motor 201 rotates in a “Fwd” direction during periods “A” and “B” so as to carry a card 1 in a forward direction toward the card carrying-out slot 119, and then the motor 201 rotates in a “Back” direction during a period “C” so as to carry the card 1 in a backward direction toward the card intake slot 101.

Furthermore, in case of the card detecting sensor 102, the card detecting sensor 102 transmits a “Lo” level signal to the CPU 304 in the period “A”. In other words, a level of a signal transmitted from the sensor 102 changes from “High” to “Lo” when the period “A” begins.

1. Period “A”: Card Carrying-In Operation

When a card 1 is inserted into the laminating apparatus 100 through the card intake slot 101 by means of manpower or a not shown carrying-in device, the card detecting sensor 102 detects that the card 1 is inserted. As shown in FIG. 4, the card detecting sensor 102 outputs a detection signal “Lo” to the CPU 304. The CPU 304 directs the servo circuit 301 in response to the detection signal “Lo” to rotate the card carrying motor 201 in a “Fwd” direction so as for the card 1 to be carried in the forward direction toward the card carrying-out slot 119.

Consequently, the card 1 is carried inside the laminating apparatus 100 while the card 1 is caught between the press shaft 103a and the card carrying roller 103b of the first card carrying-in roller section R1, and succeedingly between the press shaft 105a and the card carrying roller 105b of the second card carrying-in roller section R2.

The laminate position sensor 104 transmits a card detection signal “Lo” to the CPU 304 when the laminating position sensor 104 detects the card 1 in succession to the card detecting sensor 102.

When the card 1 is carried inside the laminating apparatus 100, the card detecting sensor 102 disables to detect the card 1 any more and transmits a card detection signal in “High” level to the CPU 304.

2. Period “B”: Card Cooling Operation

When the card 1 passes through the laminating position sensor 104, the detection signal “Lo” of the laminating position sensor 104 become a “High” level in succession to the card detecting sensor 102.

More specifically, when the laminating position sensor 104 disables to detect the card 1 any more, the laminating position sensor 104 transmits a card detection signal in “High” level to the CPU 304. The CPU 304 activates the cooling fan 120 to turn “ON” through the drive amplifier 305 at the moment when the laminating position sensor 104 disables to detect the card 1.

When the laminating position sensor 104 disables to detect the card 1 while the card 1 is carried in the forward direction, the card 1 is located at a position, which is short of the laminating roller section LR, at where a front end tip of the card 1 begins to be caught in the laminating roller section LR, wherein the front end tip is one tip of the card 1 toward the card carrying-out slot 119 along the forward direction, and the other tip toward the card intake slot 101 is referred to as a back end tip.

Further, at the time when the card 1 is located at the above-mentioned position, the heat roller 106a is separated from the heat press shaft 106b of the laminating roller section LR. The card 1 is carried through a gap between the heat roller 106a and the heat press shaft 106b in the forward direction toward the card carrying-out slot 119, and then the card 1 is cooled down as low as the normal temperature by the cooling fan 120.

3. Period “C”: Card Inversely Carrying Operation

When the front end tip of the card 1 reaches to a position at where the card carrying-out sensor 108 is allocated, as shown in FIG. 4, the card carrying-out sensor 108 transmits a card detection signal “Lo” to the CPU 304.

In response to the card detection signal “Lo” transmitted from the card carrying-out sensor 108, the CPU 304 directs the servo circuit 301 to rotate the card carrying motor 201 in a “Back” direction so as to carry the card 1 in the backward direction toward the card intake slot 101.

Accordingly, the card 1 is carried in the backward direction toward the card intake slot 101 through the laminating roller section LR by way of the second card carrying-in roller section R2. During the inversely carrying operation of the card 1, the card 1 is also cooled down by the cooling fan 120 when the card 1 is carried across a front of the cooling fan 120 in the backward direction.

4. Period “D”: End of Cooling Operation and Setting Operation of Laminating Position

When the laminating position sensor 104 detects the back end tip of the card 1 toward the card intake slot 101 and transmits a card detection signal “Lo” to the CPU 304, the CPU 304 stops the cooling fan 120 blowing and the card carrying motor 201 rotating. Consequently, the card cooling operation phase ends hereupon.

Continuously, the laminating operation phase begins in succession to the card cooling operation phase. The laminating operation phase is described in detail next.

5. First Period: Laminating Position Setting Operation

When a prescribed period of time has elapsed after the period “D” ended, the CPU 304 activates the card carrying motor 201 to rotate in the “Fwd” direction, that is, to carry the card 1 in the forward direction toward the laminating roller section LR or the card carrying-out slot 119.

Further, the CPU 304 activates the film take-up motor 209 to rotate in the “Fwd” direction so as to carry the laminate film 2 in the arrow “B” direction, and then the CPU 304 also directs the film take-up motor 209 to stop at a moment when the film mark sensor 112 detects a film mark 2c on the substrate 2b of the laminate film 2 and transmits a detection signal “Lo” to the CPU 304.

Accordingly, the laminate film 2 is positioned.

6. Second Period: Heat Roller Pressing Operation

Successively, the CPU 304 directs the servo circuit 302 to drive the heat cam motor 206 to rotate in a “Down” direction so as to rotate the heat cam 116. The heat cam 116 moves the heat roller 106a downward toward the heat press shaft 106b.

7. Third Period: Laminating Operation

When an output signal “High” outputted from the heat cam pressure position sensor 117 is transmitted to the CPU 304, the CPU 304 directs the servo circuit 302 to stop the heat cam motor 206 rotating in response to the output signal “High”. The heat cam motor 206 is stopped rotating when it is confirmed that the heat roller 106a reaches to a position at where the heat roller 106a is pressed against the heat press shaft 106b.

Then, the CPU 304 activates the card carrying motor 201 through the servo circuit 301 so as to carry the card 1 in the forward direction or the card carrying-out direction at the laminating speed V2. A distance of the card 1 to be carried in the forward direction at the laminating speed V2 is at least a maximum length along the card 1 in the carrying direction of the card 1 within an area for laminating the protective film 2a on the surface 1a of the card 1.

Further, at the same time, the CPU 304 directs the servo circuit 303 to rotate the film take-up motor 209 so as to take up the laminate film 2 in a take-up direction or in the arrow “B” direction shown in FIGS. 1 and 5(a) in synchronism with the laminating speed V2.

As shown in FIG. 4, the card carrying motor 201 is controlled to rotate in the “Fwd” direction during the third period or the laminating operation. The third period is described in detail hereupon.

The CPU 304 through the servo circuit 301 controls the laminating speed V2 during the third period. With referring to FIGS. 8(a) to 8(c), a controlling method of the laminating speed V2 is depicted.

FIGS. 8(a) to 8(c) are graphs exhibiting control patterns of a laminating speed V2 in a linear mode, a multistep mode and a single step mode respectively, wherein the control pattern is conducted in the laminating apparatus 100 according to the first embodiment of the present invention. In FIG. 8(a), the laminating speed V2 is controlled to be 4 mm/s at a moment “ts” when the front end tip of the card 1 starts to pass through the laminating roller section LR, wherein the moment “ts” is referred to as “starting moment of thermo compression bonding”. A laminating speed at the “starting moment of thermo compression bonding” is defined as V2s, wherein the speed V2s is referred to as “laminate starting moment speed”. The “laminate starting moment speed” V2s is 4 mm/s hereupon. The “starting moment of thermo compression bonding” and a “finishing moment of thermo compression bonding” (will be detailed) of the card 1 are detected by a card positioning sensor (not shown).

It is also applicable for detecting the starting or finishing moment that the starting or finishing moment is detected by change of pressure to be applied to the heat roller 106a, wherein the change of pressure corresponds to change of thickness while the card 1 passes through the laminating roller section LR.

As shown in FIG. 8(a), the laminating speed V2 is linearly decelerated by degree in response to a carrying amount of the card 1 while the thermo compression bonding is being progressed in accordance with the card 1 being carried. The laminating speed V2 is controlled to be a speed slower than the “laminate starting moment speed” V2s at a moment “tf” in a final stage of the thermo compression bonding process when the back end tip of the card 1 leaves from the heat roller 106a, wherein the moment “tf” is referred to as “finishing moment of thermo compression bonding”. The laminating speed V2 at the “finishing moment of thermo compression bonding” is set to be 3 mm/s and the speed is defined as V2f, wherein the speed V2f is referred to as “laminate finishing moment speed”.

By linearly controlling the laminating speed V2 as shown in FIG. 8(a), a heat quantity per unit time, which is applied to the card 1 per unit length in the card carrying direction, gradually increases along the card 1 in the direction toward the back end tip of the card 1. Consequently, although temperature of the heat roller 106a gradually decreases in accordance with progress of the thermo compression bonding process, the reduced temperature of the heat roller 106a is compensated by the heat quantity to be applied to the card 1, and the card 1 results in being uniformly heated so as to be constant temperature.

Accordingly, the protective film 2a is bonded on the surface 1a of the card 1 with keeping uniform and sufficiently high adhesive strength without raising temperature of the heat roller 106a more than necessary as the conventional method does.

Further, the front end portion of the card 1 is conducted through the laminating process in lower temperature than that of the conventional method, so that the card 1 enables to be prevented from being deformed.

It is desirable for the above-mentioned characteristic of decelerating the laminating speed V2 during the laminating operation to be set so as to compensate a lowering temperature characteristic of the heat roller 106a as accurate as possible.

With respect to such a compensating method, there exists one method, which is configured such that the CPU 304 controls the laminating speed V2 in response to change of surface temperature of the heat roller 106a, wherein the surface temperature is detected by a temperature sensor to be installed nearby the heat roller 106a.

In this particular case, it shall be understood that a nonlinear controlling method is applicable for controlling the laminating speed V2 other than the linear controlling method as shown in FIG. 8(a).

Further, eliminating the temperature sensor by approximately compensating the lowering temperature characteristic of the heat roller 106a enables to simplify the configuration of the lowering temperature compensating method mentioned above.

In this specific case, the CPU 304 controls the laminating speed V2 by a stepped controlling method, which is constituted by a plurality of steps or a single step as shown in FIG. 8(b) or 8(c) in accordance with a degree of approximation. It is applicable for the configuration of the approximately compensating method that a characteristic of the approximate compensation is previously prescribed and stored in a not shown memory device.

Further, it is also applicable for the configuration of the approximately compensating method that an external computer through the CPU 304 controls the laminating speed V2.

A degree of approximating enables to be arbitrary designated by a user externally.

Further, it is also applicable for the approximately compensating method that the characteristic of the approximate compensation enables to be fine-tuned in accordance with a material of the card 1 or the laminate film 2.

Referring back to FIG. 4, further operations in succession to the third period are depicted.

8. Fourth Period: Operations of Separating Heat Roller and Peeling off film

The CPU 304 through the servo circuit 302 activates the heat cam motor 206 to rotate so as to move the heat roller 106a upward, and then the CPU 304 stops the heat cam motor 206 rotating when a detection signal “High” of the cam section 116a outputted from the heat cam stand-by position sensor 118 is inputted into the CPU 304.

On the other hand, the CPU 304 activates the card carrying motor 201 to carry the card 1 in the forward direction as far as a prescribed distance, and then stops the card 1 moving.

Further, the CPU 304 activates the cooling fan 120 to turn “ON” so as to cool down the laminated card 1.

When the front end tip of the card 1 reaches to the guide shaft 114 while the card 1 and the laminate film 2 are integrally carried in the forward direction toward the card carrying-out slot 119, the substrate 2b of the laminate film 2 is pulled obliquely upward in the arrow “B” direction in FIGS. 1 and 5(a) in the downstream side of the second guide roller 114.

Accordingly, the substrate 2b is separated from the laminate film 2 and taken up by the take-up reel 115 while the protective film 2a is bonded on the surface 1a of the card 1.

As shown in FIG. 5(b), a film mark 2c is marked on the substrate 2b of the laminate film 2 in response to a prescribed bonding pitch of the protective film 2a, which is affixed on the substrate 2b. When the end mark sensor 111 detects the film mark 2c, as shown in FIG. 4, the end mark sensor 111 transmits a “Lo” level signal to the CPU 304, and then the CPU 304 stops the film take-up motor 209 rotating.

On the other hand, in case the laminate film 2 is an overlay type film, rotation of the film take-up motor 209 is interrupted in synchronism with stopping the card carrying motor 201 rotating.

9. Fifth Period: Card Carrying-Out Operation

The CPU 304 directs the servo circuit 301 to drive the card carrying motor 201 to rotate in the “Fwd” direction, and activates the card carrying rollers 107b and 109b so as to carry the card 1 in the forward direction toward the card carrying-out slot 119. Then the CPU 304 directs the servo circuit 301 to stop the card carrying motor 201 rotating subsequently the card carrying-out sensor 108 disables to detect the card 1 any more. Consequently, the card 1 laminated with the protective film 2a, that is, the laminated card 1 is carried out externally from the card carrying-out slot 119 of the laminating apparatus 100.

Accordingly, as detailed above, the card 1 is laminated with the protective film 2a by applying the operations detailed in the first to fifth periods mentioned above.

### Second Embodiment

FIG. 7 is a plan view showing a frame format of a card printing apparatus according to a second embodiment of the present invention.

With referring to FIG. 7, a card printing apparatus, which is equipped with both a printing function for printing information on a card and a laminating function for conducting a laminating process on a surface of a card that is printed by means of the printing function, is described in detail next.

As shown in FIG. 7, a card printing apparatus 50 is composed of a printing section 50P and a laminating process section 50L. A fundamental configuration of the laminating process section 50L is similar to that of the laminating apparatus 100 according to the first embodiment of the present invention shown in FIG. 1.

A printing method of the card printing apparatus 50 is not limited to a particular one. However, it shall be understood that the card printing apparatus 50 enables to ensure a laminated card more excellent in quality with effectively preventing the card from warping even by the thermal transfer printing method, in particular, which requires heating to be applied to the card.

In FIG. 7, a card 1, which is inserted into the card printing apparatus 50 through a card intake slot 51 by means of manpower or a not shown inserting device, is carried to an internal printing head section “H” by means of a first card carrying-in roller section T1 that is constituted by a pair of rollers 52a and 52b.

The printing head section “H” is composed of a thermal head 57, which is mounted with printing ink, and a platen roller 55, which pushes a surface 1a for printing of the card 1 upward against the thermal head 57.

The thermal head 57 prints a prescribed letter or image on the surface 1a of the card 1 by heating the mounted printing ink in response to instructions from a not shown printing control section.

After the card 1 is printed, the printed card 1 is carried into the laminating process section 50L, which is allocated adjacent to the printing section 50P, by means of a second card carrying-in roller section T2 that is constituted by a pair of rollers 53a and 53b.

In the laminating process section 50L, the printed card 1, which is carried therein from the printing section 50P, is carried to a laminating section (hereinafter referred to as laminating roller section) LR for thermo compression bonding by means of a third card carrying-in roller section T3 that is constituted by a pair of rollers 54a and 54b.

Configurations and operations of the laminating roller section LR and other sections and components, which are allocated in a downstream side of the laminating roller section LR, are similar to those of the laminating apparatus 100 according to the first embodiment of the present invention.

The card 1 of which surface 1a is conducted through the laminating process, is finally carried out from the card printing apparatus 50 through a card carrying-out slot 56.

In the above-mentioned configuration of the card printing apparatus 50, as shown in FIG. 7, a cooling fan 120 is allocated between the laminating roller section LR and a second guide shaft 114, which functions as a separating section for separating the protective film 2a from the substrate 2b of the laminate film 2.

Prior to the laminating process, the card 1 that is printed in the printing section 50P is once passed through the laminating roller section LR without being laminated, and carried as far as a position at where the card 1 confronts with the cooling fan 120, and then the card 1 is cooled down by the cooling fan 120 thereat.

Succeedingly, the cooled-down card 1 is carried back in the backward direction toward the card intake slot 51 as far as an upstream side of the laminating roller section LR. Then, the card 1 is carried once again in the forward direction toward the card carrying-out slot 56, and the card 1 is conducted through the laminating process in the laminating roller section LR.

Accordingly, the card 1 is already cooled down as low as the order of the normal temperature when the card 1 is conducted through the laminating process in the laminating roller section LR although the card 1 is carried out from the printing section 50P as the card 1 still keeps higher temperature.

By installing a temperature sensor for measuring surface temperature of a card 1 immediately before being carried to the laminating roller section LR, it is acceptable for the “laminate starting moment speed” V2s to be controlled in response to surface temperature of the card 1 that is measured by the temperature sensor.

More specifically, the “laminate starting moment speed” V2s enables to be controlled in response to temperature of a card 1 immediately before being carried to the laminating roller section LR. The higher the temperature of the card 1 immediately before being carried to the laminating roller section LR is, the faster the “laminate starting moment speed” V2s is designated to be. By this particular speed controlling method of the card 1, a heat quantity to be applied to the card 1 from the heat roller 106a is reduced with respect to a card 1 that is high in temperature.

Accordingly, making sum total of an original heat quantity, which is originally possessed by the card 1 at the time when the card 1 is carried in the laminating roller section LR, and an additional heat quantity, which is applied to the card 1 during the laminating process, to be an ideal heat quantity necessary for conducting an optimum laminating process enables to be realized by controlling the carrying speed of the card.

In this case, the above-mentioned cooling down process, which is conducted by the cooling fan 120 prior to the laminating process, enables to be eliminated.

Accordingly, the above-mentioned configuration enables to conduct the laminating process in stable condition without being affected by temperature of the card 1, and further the configuration enables to ensure a laminated card in higher quality.

It shall be understood that the configuration of making the total of the original and additional heat quantities to be the ideal heat quantity is also applicable for the laminating apparatus 100 according to the first embodiment of the present invention.

As mentioned above, in the laminating apparatus 100 according to the first embodiment and the card printing apparatus 50 according to the second embodiment, the card 1 is cooled down as low as the order of the normal temperature by the cooling fan 120, which is allocated in the downstream side of the laminating roller section LR, prior to thermally compression bonding the laminate film 2 on the card 1, and succeedingly the laminating process is conducted to the card 1.

Further, by eliminating the cooling down process to be conducted prior to the laminating process, the laminating apparatus 100 and the card printing apparatus 50 are constituted such that the laminating speed V2 enables to be controlled in response to temperature of the card 1 immediately before being carried in the laminating roller section LR.

By this configuration, although a card 1 that is high in temperature is inserted into the laminating apparatus 100 or carried in the laminating process section 50L of the card printing apparatus 50, the card 1 is prevented from being excessively heated so high as to be higher temperature more than necessary due to accumulated heating caused by the thermo compression bonding. Consequently, the card 1 is effectively prevented from being deformed.

Particularly, in case the card 1 is made from a cheaper material having less heat resistance such as PVC, the above-mentioned configurations exhibit extremely distinctive effects.

Further, as mentioned above, the card 1 is not only conducted through the laminating process at optimum temperature but also cooled down to the order of the normal temperature by the cooling fan 120 prior to separating the substrate 2b from the laminate film 2 or peeling off the protective film 2a from the substrate 2b even after the temperature of the card 1 is raised due to the laminating process.

Accordingly, the laminated card 1 is prevented from being deformed by a force applied to the card 1 when separating the substrate 2b from the laminate film 2.

Furthermore, as mentioned above, in the first and second embodiment, the cooling fan 120 is controlled so as to send air only when a card 1 is positioned at a location where the card 1 confronts with the cooling fan 120. Consequently, there is no possibility of cooling down the heat roller 106a so excessively as to affect the heat roller 106a to function.

In the laminating apparatus 100 according to the first embodiment of the present invention, the cooling fan 120 enables to be allocated at any position between the laminating roller section LR and the separating section of the laminate film 2 in the downstream side of the laminating roller section LR.

Further, in the card printing apparatus 50 according to the second embodiment, the cooling fan 120 also enables to be allocated at any position between the laminating roller section LR and the separating section of the laminate film 2 in the downstream side of the laminating roller section LR.

Furthermore, the present invention mentioned above also enables to solve problems caused by heat other than warpage of a card.

As for one of the heat related problems, it is necessary for a substrate of a laminate film to be peeled off from the laminate film after the laminating process. In the peeling off process, in case temperature of the laminate film is too high, adhesive strength between the substrate and a resin layer is made stronger. Consequently, the substrate is hardly peeled off from the laminate film, and resulting in arising a problem of defective peeling-off.

With respect to a laminating method, generally, there are several methods. One of them is the laminating method described in the first and second embodiments of the present invention and another method is such that a substrate of a laminate film itself is bonded on a surface of a card and the substrate is made to be a protective film.

In case of the other method mentioned above, a laminate film is constituted by a substrate and an adhesive layer. The laminate film is previously cut halfway along a borderline of an area to be bonded, that is, contour of a card normally.

Then, after the laminating process is conducted, a part of the laminate film, which is not bonded on a card, is separated from the laminate film so as to be cut off along the halfway cut portion.

In this particular case, if temperature of the laminate film was higher than the normal condition during the separating process, it was not easy to cut the laminate film along the halfway cut portion because the laminate film was softened by the higher temperature. Consequently, there existed some possibility of arising a problem of defective separation. However, as disclosed in the present invention, a card and a laminate film are never heated excessively during the laminating process and further the laminated card is cooled down after the laminating process. Accordingly, such a problem of defective separation enables to be more effectively prevented according to synergy effect of the present invention.

On the other hand, in the process of peeling off or separating a substrate or a portion not to be bonded of a laminate film from a card, in any case, the card is applied with force in a direction of peeling off the laminate film.

In case temperature of the card is high, the force to be applied to the card easily creates a problem of deforming the card.

According to the first and second embodiments of the present invention mentioned above, a card or a laminate film is never heated excessively during the laminating process, so that such a problem is effectively prevented.

In addition thereto, according to the present invention, a laminated card is cooled down by wind from a fan after the laminating process is conducted.

Accordingly, the laminated card is more effectively protected from warpage caused by peeling off the laminate film according to synergy effect of the present invention.

In the first and second embodiments of the present invention, the card carrying speed V1 of the card 1 in each period of operation other than the laminating operation period enables to be adjusted arbitrarily as far as the card 1 is excellently cooled down. However, in order to manufacture a laminated card efficiently, the card carrying speed V1 shall be set to a higher speed as fast as possible.

According to the present invention, occurrence of defects enables to be reduced during a separating process of a laminate film.

Further, after a card has been laminated, warpage of the card or changing in characteristics of the card with time enables to be improved.

Accordingly, a laminated card, which is low in price and excellent in quality, enables to be manufactured.

While the invention has been described above with reference to specific embodiments thereof, it is apparent that many changes, modifications and variations in the arrangement of equipment and devices can be made without departing from the invention concept disclosed herein.

For example, in the first and second embodiments, it is described such that the card 1 before being laminated is cooled down by the cooling fan 120 while the card 1 is passed through the laminating roller section LR in the forward direction without conducting the thermo compression bonding process or the laminating process, and passed once again through the laminating roller section LR without conducting the laminating process while carrying the card 1 in the upstream direction of the laminating roller section LR or in the backward direction, and then the card 1 is laminated with the protective film 2a on the surface 1a of the card 1 through the laminating process while the card 1 is carried in the downstream direction or in the forward direction, and finally the laminated card 1 is carried out through the card carrying-out slot 119 or 56. However, the configuration is not limited to the one specifically described above.

It is also acceptable for the configuration of the laminating apparatus or the laminating process section to be arranged such that the laminating process is conducted by the laminating roller section LR at a time when the card 1 is carried in the backward direction after the card 1 is cooled down, and then the laminated card 1 is carried in the forward direction through the laminating roller section LR without conducting the thermo compression bonding process, and finally the laminated card 1 is carried out through the card carrying-out slot 119 or 56.

Further, in the first and second embodiments, the cooling fan 120 is exemplified as a cooling device. However, such a cooling device is not limited to a fan. By allocating a cooling body that is cooled by using Peltier elements, for example, on the card carrying route, it is acceptable for cooling the card 1 that the card 1 is contacted with or approached to the cooling body so as to cool down the card 1. With respect to a cooling device, commonly known devices enable to be used for such a cooling device.

Furthermore, in the first and second embodiments, it is exemplified that the motors 201, 206 and 209 are controlled by means of the servo circuits 301 to 303 respectively. However, by using stepping motors for the motors 201, 206 and 209, the controlling system enables to be configured such that the CPU 304 controls directly the motors 201, 206 and 209 without using the servo circuits 301 to 303.

With respect to information to be recorded or printed on a surface of a card, such information are letters including numbers and signs and images including hologram.

Further, with respect to a recording method, printing is a typical example. However, it shall be understood that there exist various kinds of recording method.

Furthermore, in the first and second embodiments, it is described that the card 1 is inserted into the apparatus through the card intake slot 101 or 51. However, the configuration of inserting the card 1 is not limited to the specific description in the embodiments. It is acceptable for the card inserting configuration that a holder containing a plurality of cards 1 is loaded into the apparatus as a card supplying device. The laminating apparatus or the card printing apparatus according to the present invention is just required for being installed with such a supplying device having a function of supplying the card 1 to the apparatus such as an inserting slot and a holder.

It will be apparent to those skilled in the art that various modification and variations could be made in the present invention without departing from the scope or spirit of the invention.

What is claimed as new and desired to be protected by Letters Patent of the United States is:

1. A manufacturing method of a laminated card formed with a protective film on a surface of a card, comprising the step of:
thermo compression bonding for thermally compression bonding a laminate film having a material for forming a protective film on at least one surface of a card while the card is carried through a thermo compression bonding section at a prescribed passing through speed,
wherein the passing through speed is designated such that a finishing moment speed when the card finishes to pass through the thermo compression bonding section is slower than a starting moment speed when the card starts to pass through the thermo compression bonding section, and
wherein the card is carried without increasing the passing through speed within a range from the starting moment speed to the finishing moment speed.

2. A laminating apparatus for manufacturing a laminated card comprising:
a laminating section for thermally compression bonding a laminate film having a material for forming a protective film on at least one surface of a card recorded with information and for bonding the protective film on the one surface of the card while the card is carried through the laminating section;
a supplying section for supplying the card to the laminating section;
carrying means for carrying the card supplied from the supplying section so as to pass through the laminating section at a prescribed passing through speed; and
a controlling section for controlling the passing through speed in the laminating section,
wherein the controlling section controls the passing through speed such that a finishing moment speed when the card finishes to pass through the laminating section is slower than a starting moment speed when the card starts to pass through the laminating section, and
wherein the controlling section controls the passing through speed so as not to be increased within a range from the starting moment speed to the finishing moment speed.

3. A card printing apparatus for manufacturing a laminated card comprising:
a printing section for printing information on at least one surface of a card; and
a laminating section for thermally compression bonding a laminate film having a material for forming a protective film on the one surface of the card printed with the information in the printing section and for bonding the protective film on the one surface of the card while the card is carried through the laminating section,
the card printing apparatus further comprising:
carrying means for supplying the card printed in the printing section to the laminating section and for carrying the card so as to pass through the laminating section at a prescribed passing through speed; and
a controlling section for controlling the passing through speed in the laminating section,
wherein the controlling section controls the passing through speed such that a finishing moment speed when the card finishes to pass through the laminating section is slower than a starting moment speed when the card starts to pass through the laminating section, and
wherein the controlling section controls the passing through speed so as not to be increased within a range from the starting moment speed to the finishing moment speed.
